(19) United States
(12) Patent Application Publication
(10) Pub. No.: US 2026/0038884 A1
(43) Pub. Date: Feb. 5, 2026

(54) BATTERY CELLS AND METHODS FOR MAKING BATTERY CELLS

(71) Applicant: GM GLOBAL TECHNOLOGY OPERATONS LLC, Detroit, MI (US)

(72) Inventors: Nathaniel Z. Hardin, Farmington Hills, MI (US); Adam Crowe, Chesterfield, MI (US)

(73) Assignee: GM GLOBAL TECHNOLOGY OPERATIONS LLC, Detroit, MI (US)

(21) Appl. No.: 18/791,754

(22) Filed: Aug. 1, 2024

(51) Int. Cl. H01M 10/42; H01M 10/0525; H01M 10/0585; H01M 50/531; H01M 50/586; H01M 50/59

(52) U.S. Cl. CPC H01M 10/4235; H01M 10/0525; H01M 10/0585; H01M 50/531; H01M 50/586; H01M 50/59; H01M 2220/20

(57) ABSTRACT

A battery cell includes a first electrode, a second electrode, and a separator that is disposed between the first and second electrodes. The first electrode has a first electrode coated active area and a first electrode tab disposed adjacent to and extending beyond the first electrode coated active area. The second electrode has a second electrode coated active area and a second electrode tab disposed adjacent to and extending beyond the second electrode coated active area. An insulating, laminate film at least partially covers the first electrode tab and couples the first and second electrodes together about the separator.

### INTRODUCTION

The disclosure generally relates to battery cells including a first electrode, a second electrode, a separator, an insulating, laminate film that couples the first and second electrodes together about the separator.

Battery cells may include an anode, a cathode, and an electrolyte. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force.

### SUMMARY

A battery cell in accordance with one or more embodiments is provided. The battery cell includes a first electrode having a first electrode coated active area and a first electrode tab disposed adjacent to and extending beyond the first electrode coated active area. A second electrode has a second electrode coated active area and a second electrode tab disposed adjacent to and extending beyond the second electrode coated active area. A separator is disposed between the first and second electrodes. An insulating, laminate film at least partially covers the first electrode tab and couples the first and second electrodes together about the separator.

In some embodiments, the insulating, laminate film at least partially covers and is coupled to both the first and second electrode tabs about the separator.

In some embodiments, the insulating, laminate film has a thickness of from about 5 to about 200 μm.

In some embodiments, the insulating, laminate film includes a polymer that is electrically insulating.

In some embodiments, the polymer is chosen from polyethylene, polypropylene, polyamide, polyvinyl chloride, polyvinylidene difluoride, silicone, or a combination thereof.

In some embodiments, the polymer forms at least part of a laminate substrate layer.

In some embodiments, the laminate substrate layer is free of adhesive.

In some embodiments, the insulating, laminate film further includes an adhesive that is disposed on the laminate substrate layer.

In some embodiments, the adhesive is chosen from an epoxy adhesive, an acrylic adhesive, a polyurethane adhesive, a silicone adhesive, or a combination thereof.

In some embodiments, the first and second electrode tabs are configured as N-type electrode tabs.

In some embodiments, the first and second electrode tabs are configured as P-type electrode tabs.

A method for making a battery cell in accordance with one or more embodiments is provided. The method includes providing a first electrode having a first electrode coated active area and a first electrode tab disposed adjacent to and extending beyond the first electrode coated active area. A second electrode is provided having a second electrode coated active area and a second electrode tab disposed adjacent to and extending beyond the second electrode coated active area. A separator is disposed between the first and second electrodes. An insulating, laminate film is formed at least partially covering the first electrode tab and coupling the first and second electrodes together about the separator.

In some embodiments, forming includes forming the insulating, laminate film at least partially covering and coupled to both the first and second electrode tabs about the separator.

In some embodiments, forming includes forming the insulating, laminate film by applying a hot melt polymer or a polymer solution at least partially covering the first electrode tab.

In some embodiments, applying includes applying the hot melt polymer or the polymer solution using a spray process or a casting process that includes a slot die.

In some embodiments, forming includes forming the insulating, laminate film by applying a laminate substrate layer, which is formed of a polymer, at least partially covering the first electrode tab.

In some embodiments, the laminate substrate layer is free of adhesive, and forming includes applying the laminate substrate layer using a hot roller process or a hot sealer process.

In some embodiments, the insulating, laminate film further includes an adhesive that is disposed on the laminate substrate layer.

In some embodiments, forming includes applying pressure and/or heat to the insulating, laminate film to couple the adhesive to the first and second electrodes about the separator.

A vehicle in accordance with one or more embodiments is provided. The vehicle includes an output device and a battery cell. The battery cell is configured to provide electrical energy to the output device the battery cell includes a first electrode having a first electrode coated active area and a first electrode tab disposed adjacent to and extending beyond the first electrode coated active area. A second electrode has a second electrode coated active area and a second electrode tab disposed adjacent to and extending beyond the second electrode coated active area. A separator is disposed between the first and second electrodes. The separator is electrically insulating and ionically conductive. An insulating, laminate film at least partially covers the first electrode tab and couples the first and second electrodes together about the separator. An electrolyte is operatively disposed between the first and second electrodes and interfaces with the separator to conduct ions between the first and second electrodes.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 illustrates a schematic view of a vehicle that includes a battery system with battery cells and an output device in accordance with the present disclosure.

FIG. 2 illustrates, in cross sectional view, a portion of a battery cell in accordance with the present disclosure.

FIG. 3A illustrates, in top view, a battery cell with P-type electrode tabs in accordance with the present disclosure.

FIG. 3B illustrates, in top view, a battery cell with N-type electrode tabs in accordance with the present disclosure.

FIG. 4 illustrates a method for making a battery cell in accordance with the present disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Unless specifically stated from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, the numerical values provided herein are modified by the term “about.”

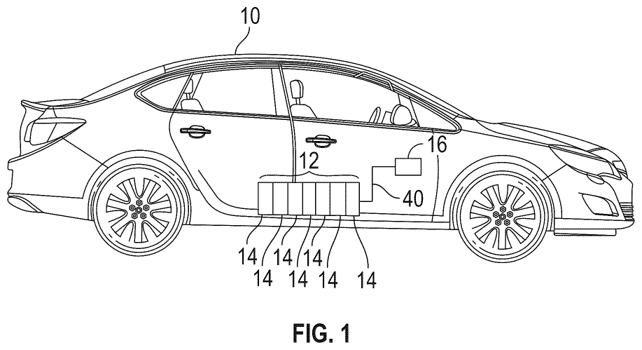

FIG. 1 schematically illustrates an exemplary device 10, e.g., a battery electric vehicle (BEV), including a battery pack 12 that includes a plurality of battery cells 14. Although the battery cells 14 are illustrated as being utilized in a BEV, it is to be understood that the battery cells 14 may be utilized in a wide range of applications and powertrains. The plurality of battery cells 14 may be connected in various combinations, for example, with a portion being connected in parallel and a portion being connected in series, to achieve goals of supplying electrical energy at a desired voltage. The battery pack 12 is illustrated as electrically connected to a motor generator unit 16 (e.g., output device) useful to provide motive force to the vehicle 10. The motor generator unit 16 may include an output component, for example, an output shaft, which transfers mechanical energy useful to provide the motive force to the vehicle 10. A number of variations to vehicle 10 are envisioned, and the disclosure is not intended to be limited to the examples provided.

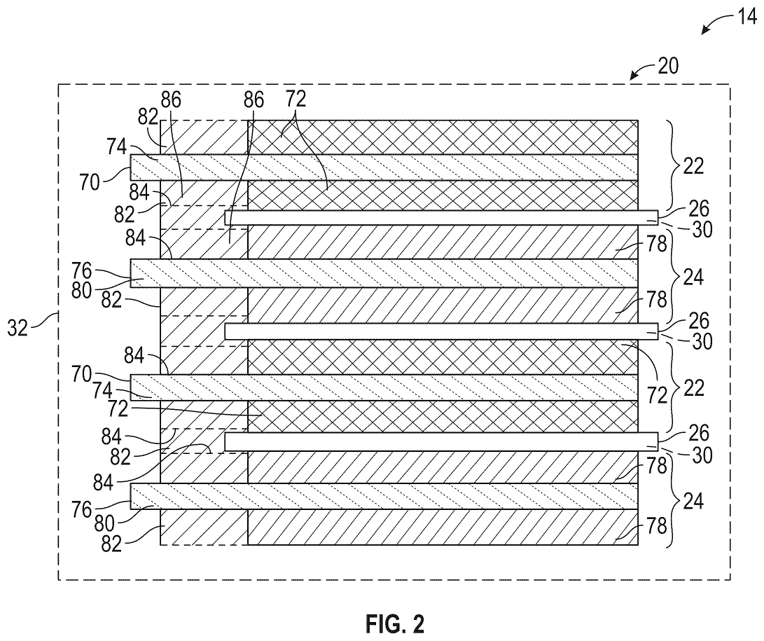

FIG. 2 schematically illustrates, in cross sectional view, an exemplary portion of a battery cell 14 of the battery pack 12. Referring to FIGS. 1 and 2, in an exemplary embodiment, the battery cell 14 is configured as a lithium-ion battery 20. The lithium-ion battery 20 includes first electrodes 22 (e.g., positive or negative electrode), second electrodes 24 (e.g., the other of the positive or negative electrode), and a corresponding separator 26 (e.g., a microporous or nano-porous polymeric separator) disposed between each of the first and second electrodes 22 and 24. An electrolyte 30 is disposed between the first and second electrodes 22 and 24 and interfaces with the separator(s) 26, for example, the electrolyte 30 is disposed in pores of the separator(s) 26. The electrolyte 30 may also be present in the first electrode(s) 22 and second electrode(s) 24, such as in their pores. As will be discussed in further detail below, a battery envelope or pouch 32 (e.g., battery encasing) is disposed about the first and second electrodes 22 and 24.

The separator 26 operates as both an electrical insulator and a mechanical support. More particularly, the separator 26 is disposed between the first electrode 22 and the second electrode 24 to prevent or reduce physical contact and thus, the occurrence of a short circuit. The separator 26, in addition to providing a physical barrier between the two electrodes 22 and 24, provides a minimal resistance path for internal passage of lithium ions (and related anions) during cycling of the lithium ions to facilitate functioning of the lithium-ion battery 20.

In one embodiment, the first electrode(s) 22 is a cathode(s) and the second electrode(s) 24 is an anode(s). The cathode includes a conductive support structure or current collector 70, for example, formed of aluminum, an alloy thereof, or other conductive support material that is partially coated with a cathode active material to define an electrode coated active area 72. As illustrated, the current collector 70 is disposed adjacent to and extends beyond the electrode coated active area 72 to define an electrode tab(s) 74. Likewise, the anode includes a conductive support structure or current collector 76, for example, formed of copper, an alloy thereof, or other conductive support material that is partially coated with an anode active material to define an electrode coated active area 78. As illustrated, the current collector 76 is disposed adjacent to and extends beyond the electrode coated active area 78 to define an electrode tab(s) 80.

In an exemplary embodiment, the lithium-ion battery 20 can generate an electric current during discharge by way of reversible electrochemical reactions that occur when the circuit 40 is closed to electrically connect the anode and cathode when the anode contains a relatively greater quantity of cyclable lithium. The chemical potential difference between the cathode and the anode drives electrons produced by the oxidation of lithium (e.g., intercalated/alloyed/plated lithium) at the anode through the circuit 40, electrically connected (e.g., directly or indirectly), for example, to the tabs 74 and 80. Lithium ions, which are also produced at the anode, are concurrently transferred through the electrolyte 30 and separator 26 towards the cathode. The electrons flow through the circuit 40 and the lithium ions migrate across the separator 26 in the electrolyte 30 to intercalate/alloy/plate into a positive electroactive material of the cathode. The electric current passing through the circuit 40 can be harnessed and directed through the motor generator unit 16 until the lithium in the anode is depleted and the capacity of the lithium-ion battery 20 is diminished. The lithium-ion battery 20 can be charged or re-energized at a desired time by connecting an external power source (e.g., charging device) to the lithium-ion battery 20 to reverse the electrochemical reactions that occur during battery discharge.

In the case of the first electrode 22 configured as a cathode, the cathode may include a thin aluminum or aluminum alloy support structure. The electrode coated active area 72 includes a cathode active material that is coated over a portion of the thin aluminum or aluminum alloy support structure. Examples of cathode active materials include, or consist of a lithium-based active material that can undergo lithium intercalation and deintercalation, alloying and dealloying, while functioning as the positive terminal material of the lithium-ion battery 20. Further, the cathode active material may include a positive electroactive material. Positive electroactive materials may include one or more transition metal cations, such as manganese (Mn), nickel (Ni), cobalt (Co), chromium (Cr), iron (Fe), vanadium (V), and combinations thereof. In this example, the electrode uncoated area that forms the tab(s) 74 includes the thin aluminum or aluminum alloy support structure that is free of positive electroactive materials.

In the case of the second electrode 24 configured as an anode, the anode may include a thin copper or copper alloy support structure. The electrode coated active area 78 includes a negative electroactive material that is coated over a portion of the thin copper or copper alloy support structure. The negative electroactive material includes a lithium host material capable of functioning as a negative terminal of the lithium-ion battery 20. Common negative electroactive materials include lithium insertion materials or alloy host materials or plating and stripping materials. Such materials can include carbon-based materials, such as lithium-graphite intercalation compounds, lithium-silicon compounds, lithium-tin alloys, or lithium titanate. In this example, the electrode uncoated area that forms the tab(s) 80 includes the thin copper or copper alloy support structure that is free of negative electroactive materials.

In an exemplary embodiment, the battery cell 14 further includes a corresponding insulating, laminate film 82 disposed between each set of the electrode tabs 74 and 80 (e.g., adjacent electrode tabs 74 and 80). As illustrated, the corresponding insulating, laminate film 82 at least partially covers a corresponding electrode tab 74 and physically and/or mechanically couples the adjacent electrodes 22 and 24 together about the separator 26. In an exemplary embodiment, the insulating, laminate film 82 is continuously present between and at least partially covers and is coupled to the adjacent first and second electrode tabs 74 and 80 about the separator 26 for each pair of electrodes 22 and 24.

The insulating, laminate film 82 is electrically insulating. In an exemplary embodiment, advantageous the insulating, laminate film 82, in addition to the separator 26, helps further prevent the occurrence of a short circuit between adjacent electrodes 22 and 24 by providing an extended insulating barrier about the lateral edges of the electrodes 22 and 24 and the separator 26. In an exemplary embodiment and as will be discussed in further detail below, physically and/or mechanically coupling adjacent electrodes 22 and 24 together at or proximate the tabs 74 and 80 helps to stabilize the positional relationship of the tabs 74 and 80 and the electrode stack during manufacturing to prevent or minimize misalignment of the tabs 74 and 80 prior to being sealed within the battery envelope 32.

In an exemplary embodiment, the insulating, laminate film 82 has a thickness of from about 5 to about 200 μm. In an exemplary embodiment, the insulating, laminate film 82 includes a polymer that is electrically insulating. Non-limiting examples of such polymer are polyethylene, polypropylene, polyamide, polyvinyl chloride, polyvinylidene difluoride, and/or silicone.

In an exemplary embodiment, the polymer forms at least part of a laminate substrate layer 84. In one example, the laminate substrate layer 84 is free of adhesive. In another example, the insulating, laminate film 82 further includes an adhesive 86 that is disposed on the laminate substrate layer 84. Non-limiting examples of such adhesives include an epoxy adhesive, an acrylic adhesive, a polyurethane adhesive, and/or a silicone adhesive. The adhesive 86 may be a pressure sensitive adhesive, a temperature sensitive adhesive (e.g., curable via heat or flowable/meltable via heat), or the like.

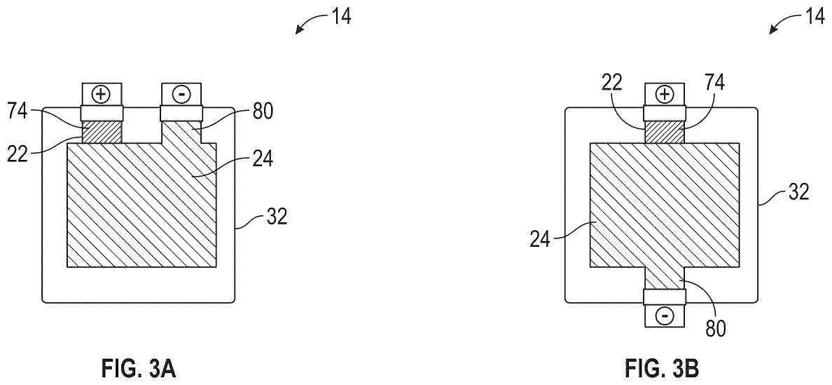

Referring to FIG. 3A, in an exemplary embodiment, the battery cell 14 is configured with the electrode tabs 74 and 80 extending outwardly from their respective electrodes 22 and 24 in the same direction. In particular, the electrode tabs 74 and 80 are configured as P-type electrode tabs.

Referring to FIG. 3B, in an exemplary embodiment, the battery cell 14 is configured with the electrode tabs 74 and 80 extending outwardly from their respective electrodes 22 and 24 in opposing or opposite directions. In particular, the electrode tabs 74 and 80 are configured as N-type electrode tabs.

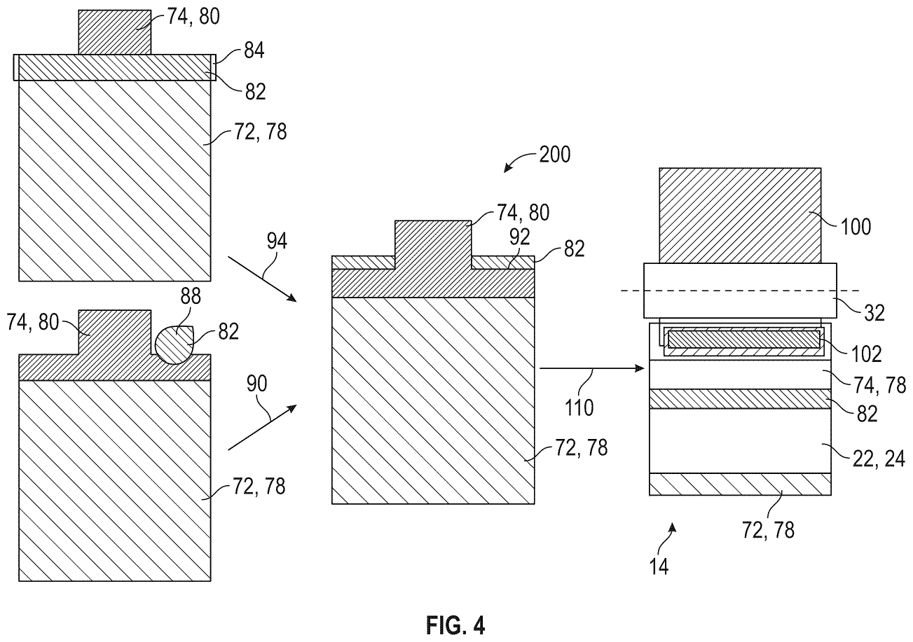

FIG. 4 illustrates a method 200 for making a battery cell 14 as discussed above in accordance with an exemplary embodiment. Referring to FIGS. 2 and 4, the method 200 includes providing a first electrode 22 having a first electrode coated active area 72 and a first electrode tab 74 disposed adjacent to and extending beyond the first electrode coated active area 78. The method 200 continues by providing a second electrode 24 having a second electrode coated active area 78 and a second electrode tab 80 disposed adjacent to and extending beyond the second electrode coated active area 78. A separator 26 is disposed between the first and second electrodes 22 and 24.

In an exemplary embodiment, an insulating, laminate film 82 is formed at least partially covering the first electrode tab 74 and couples the first and second electrodes 22 and 24 together about the separator 26. In one or more embodiments disclosed herein, the insulating, laminate film 82 is formed at least partially covering and coupled to both the first and second electrode tabs 74 and 80 about the separator 26.

In at least one example, the insulating, laminate film 82 is formed by applying a hot melt polymer or a polymer solution 88 at least partially covering the first electrode tab 74. The hot melt polymer or the polymer solution 88 may be formed using a spray process or a casting process 90 that includes a slot die to form a layer 92 of the insulating, laminate film 82. In one or more other examples, the insulating, laminate film 82 is formed by applying a laminate substrate layer 84, which is formed of a polymer, at least partially covering the first electrode tab 74. The laminate substrate layer 84 may be free of adhesive and applied using a process 94, such as, for example, a hot roller process or a hot sealer process 94. Alternatively, the insulating, laminate film 82 may include an adhesive 86 that is disposed on the laminate substrate layer 84 and applied using a process 94 that includes, for example, applying heat and/or pressure to the insulating, laminate film 82 to couple the adhesive 86 to the first and second electrodes 22 and 24 about the separator.

The method 200 continues by arranging (indicated by arrow 110) the stack of first and second electrodes 22 and 24 in a battery envelope 32 and sealing the battery envelope 32, for example, via a welding process 102 with the electrode tabs 74 and 80 couple to a lead tab(s) 100 that extends outside of the battery envelope 32 to couple with the circuit 40 illustrated in FIG. 1. As discussed above, in an exemplary embodiment, physically and/or mechanically coupling adjacent electrodes 22 and 24 together with the insulating, laminate film 82 at or proximate the tabs 74 and 80 helps to stabilize the positional relationship of the tabs 74 and 80 and the electrode stack during manufacturing to prevent or minimize misalignment of the tabs 74 and 80 prior to being sealed within the battery envelope 32.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A battery cell comprising:
a first electrode having a first electrode coated active area and a first electrode tab disposed adjacent to and extending beyond the first electrode coated active area;
a second electrode having a second electrode coated active area and a second electrode tab disposed adjacent to and extending beyond the second electrode coated active area;
a separator disposed between the first and second electrodes; and
an insulating, laminate film at least partially covering the first electrode tab and coupling the first and second electrodes together about the separator.

2. The battery cell of claim 1, wherein the insulating, laminate film at least partially covers and is coupled to both the first and second electrode tabs about the separator.

3. The battery cell of claim 1, wherein the insulating, laminate film has a thickness of from about 5 to about 200 μm.

4. The battery cell of claim 1, wherein the insulating, laminate film comprises a polymer that is electrically insulating.

5. The battery cell of claim 4, wherein the polymer is chosen from polyethylene, polypropylene, polyamide, polyvinyl chloride, polyvinylidene difluoride, silicone, or a combination thereof.

6. The battery cell of claim 4, wherein the polymer forms at least part of a laminate substrate layer.

7. The battery cell of claim 6, wherein the laminate substrate layer is free of adhesive.

8. The battery cell of claim 6, wherein the insulating, laminate film further comprises an adhesive that is disposed on the laminate substrate layer.

9. The battery cell of claim 8, wherein the adhesive is chosen from an epoxy adhesive, an acrylic adhesive, a polyurethane adhesive, a silicone adhesive, or a combination thereof.

10. The battery cell of claim 1, wherein the first and second electrode tabs are configured as N-type electrode tabs.

11. The battery cells of claim 1, wherein the first and second electrode tabs are configured as P-type electrode tabs.

12. A method for making a battery cell, the method comprising:
providing a first electrode having a first electrode coated active area and a first electrode tab disposed adjacent to and extending beyond the first electrode coated active area;
providing a second electrode having a second electrode coated active area and a second electrode tab disposed adjacent to and extending beyond the second electrode coated active area;
disposing a separator between the first and second electrodes; and
forming an insulating, laminate film at least partially covering the first electrode tab and coupling the first and second electrodes together about the separator.

13. The method of claim 12, wherein forming comprises forming the insulating, laminate film at least partially covering and coupled to both the first and second electrode tabs about the separator.

14. The method of claim 12, wherein forming comprises forming the insulating, laminate film by applying a hot melt polymer or a polymer solution at least partially covering the first electrode tab.

15. The method of claim 14, wherein applying comprises applying the hot melt polymer or the polymer solution using a spray process or a casting process that includes a slot die.

16. The method of claim 12, wherein forming comprises forming the insulating, laminate film by applying a laminate substrate layer, which is formed of a polymer, at least partially covering the first electrode tab.

17. The method of claim 16, wherein the laminate substrate layer is free of adhesive, and wherein forming includes applying the laminate substrate layer using a hot roller process or a hot sealer process.

18. The method of claim 16, wherein the insulating, laminate film further comprises an adhesive that is disposed on the laminate substrate layer.

19. The method of claim 18, wherein forming comprises applying pressure and/or heat to the insulating, laminate film to couple the adhesive to the first and second electrodes about the separator.

20. A vehicle comprising:
an output device; and
a battery cell that is configured to provide electrical energy to the output device, the battery cell comprising:
a first electrode having a first electrode coated active area and a first electrode tab disposed adjacent to and extending beyond the first electrode coated active area;
a second electrode having a second electrode coated active area and a second electrode tab disposed adjacent to and extending beyond the second electrode coated active area;
a separator disposed between the first and second electrodes, wherein the separator is electrically insulating and ionically conductive;
an insulating, laminate film at least partially covering the first electrode tab and coupling the first and second electrodes together about the separator; and
an electrolyte operatively disposed between the first and second electrodes and interfacing with the separator to conduct ions between the first and second electrodes.
